(19) United States
(12) Patent Application Publication
(10) Pub. No.: US 2017/0339940 A1
(43) Pub. Date: Nov. 30, 2017

(54) Mintey Mouse Systems

(71) Applicant: Kim Galway, Richmond Hill (CA)

(72) Inventor: Kim Galway, Richmond Hill (CA)

(21) Appl. No.: 15/168,485

(22) Filed: May 31, 2016

(51) Int. Cl. A01M 29/12; A01M 13/00

(52) U.S. Cl. CPC A01M 29/12; A01M 13/006

(57) ABSTRACT

A mintey mouse system for discouragement of rodent occupation. The mintey mouse assembly has an outer container and an inner volume. The outer container may have a lid, airflow ventilation, and anti-tipping feet. The airflow ventilation may allow the essential oil liquid vapors to diffuse into the ambient atmosphere. The inner volume may be structured and arranged to house a bottle and a bottle receptacle. The bottle may have a volume structured and arranged for containing and controllably diffusing a quantity of the essential oil liquid therefrom. The essential oil liquid may be peppermint oil, useful as a rodent deterrent. The lid may provide an opening to access the inner volume for replacing and alternately removing the bottle for refilling with the essential oil liquid.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pest deterrents and more specifically relates to a mintey mouse system.

### 2. Description of Related Art

The best way to deal with unwanted mice and rats is to plug all holes and entry points for a building to completely keep them out, but this isn't always possible. Entry points are often so small or so many in number that the holes may too difficult to find or may be inaccessible, especially in shared buildings where rodents may travel between walls and along roofs from one unit to another.

Some methods of dealing with unwanted mice and rats are to use poisons and traps. Poisons are hurting the ecological cycle and are having a negative impact on our environment. In addition, numerous pets die each year from consuming a poisoned, or already dead, rodent. Traps are a lot of work and are very unpleasant when they kill rodents in any variety of ways. If the trap does not completely kill the rodent, the person who set the trap has a dilemma on how to deal with the rodent. In addition, traps do not perform any kind of deterrent function to dissuade rodents from occupying the space. A suitable solution is desired.

Several attempts have been made to solve the above-mentioned problems such as those found in U.S. Pat. and Pub. Nos. 2012/0061486 to Atkinson, et. al.; 2015/0208638 to Munsell, et. al.; U.S. Pat. No. 4,663,315 to Hasegawa et. al.; U.S. Pat. No. 9,210,924 to Terrell; U.S. Pat. No. 7,014,819 to Brown, et. al.; and Canadian Pat No. 2,678,357 to De. This art is representative of pest deterrents. However, none of the above inventions and patents, taken either singly or in combination, is seen to describe the invention as claimed.

Preferably, pest deterrents should provide discouragement for rodent occupation and, yet would operate reliably and be manufactured at a modest expense. Thus, a need exists for a reliable mintey mouse system to avoid the above-mentioned problems.

### BRIEF SUMMARY OF THE INVENTION

In view of the foregoing disadvantages inherent in the known discouragement for rodent occupation art, the present invention provides a novel pest deterrent. The general purpose of the present invention, which will be described subsequently in greater detail is to provide a mintey mouse system.

A MINTEY MOUSE™ system is disclosed herein, in a preferred embodiment, which may be structured and arranged in combination to provide a long-lasting rodent repellant for use. The mintey mouse system may comprise the mintey mouse assembly. The mintey mouse assembly may comprise the outer container. The outer container may comprise the inner volume, the non-corrosive reservoir, the lid, the airflow ventilation, and the anti-tipping feet. The non-corrosive reservoir may comprise the diffusing agent. The diffusing agent may comprise cotton. The outer container may comprise a cubic-shape, useful for placing the outer container in a corner of a room. The outer container may comprise insular materials. The lid may comprise an opening to access the inner volume for replacing and alternately removing the bottle for refilling with the essential oil liquid, or alternately replacing the bottle, the non-corrosive rubber drip collar, the non-corrosive nipple, and the non-corrosive tube. The anti-tipping feet comprise an x-shape, useful for providing stability for the mintey mouse assembly.

The inner volume may comprise the hook, the bottle-sack, the bottle and the bottle receptacle. The hook may comprise an attacher, useful for removably-coupling the hook to the inner volume of the outer container. The bottle-sack may be removably-coupled with the hook, useful for providing central suspension of the bottle in the inner volume. The bottle may comprise the essential oil liquid suitable for dispersion therefrom. The bottle may comprise a volume structured and arranged for containing and controllably diffusing a quantity of the essential oil liquid that may last one year without requiring refill. The essential oil liquid may comprise non-poisonous agents, which are environmentally friendly, The essential oil liquid may comprise peppermint oil, useful as a rodent deterrent. The essential oil liquid may comprise anti-oxidation ingredients, useful for maintaining strength of the peppermint oil. The essential oil liquid may comprise non-toxic anti-freeze properties, useful for placing the mintey mouse assembly in cold locations. The bottle is removably-insertable to the bottle-sack useful for retaining the bottle in an opening-down position while removably-attached with the bottle receptacle. The bottle receptacle may comprise the non-corrosive rubber drip collar, the non-corrosive nipple, and the non-corrosive tube, useful for allowing the essential oil liquid vapors to diffuse into an ambient atmosphere. The non-corrosive tube may comprise the non-corrosive valve. The non-corrosive valve may comprise preset flow rates and an on/off condition, useful for controlling an amount of the essential oil liquid for diffusion.

The mintey mouse system may further comprise a kit including the mintey mouse assembly; a refill vial of the essential oil liquid, or alternately a replacement of the bottle, the non-corrosive rubber drip collar, the non-corrosive nipple, and the non-corrosive tube; and a set of user instructions. A method of using a mintey mouse system may comprise the steps of: opening a lid of an outer container; removing the bottle; filling the bottle with essential oil liquid; replacing the bottle in the outer container; and placing a mintey mouse assembly in a desired location for rodent repelling. The method of use may further comprise the steps of: replacing the bottle, a non-corrosive rubber drip collar, a non-corrosive nipple, and a non-corrosive tube; and removing the mintey mouse assembly when use is no longer desired.

The present invention holds significant improvements and serves as a discouragement for rodent occupation. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, mintey mouse system, constructed and operative according to the teachings of the present invention.

FIG. 1 shows a perspective view illustrating a mintey mouse system during an ‘in-use’ condition showing mintey mouse assembly according to an embodiment of the present invention.

FIG. 2 is a perspective view illustrating the mintey mouse system comprising a mintey mouse assembly providing a deterrent according to an embodiment of the present invention of FIG. 1.

FIG. 3 is an exploded view illustrating mintey mouse system according to an embodiment of the present invention of FIGS. 1-2.

FIG. 4 is a cutaway view illustrating mintey mouse system according to an embodiment of the present invention of FIGS. 1-3.

FIG. 5 is a flowchart illustrating a method of use for mintey mouse system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to pest deterrents and more particularly to a mintey mouse system as used to improve the discouragement for rodent occupation.

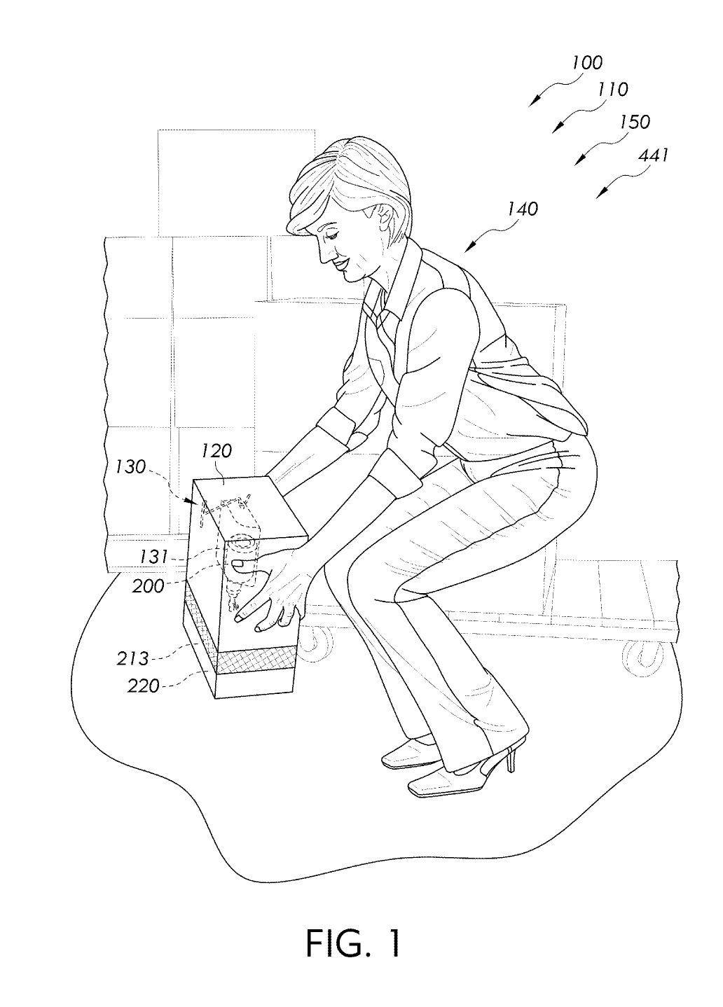

Referring to the drawings by numerals of reference there is shown in FIG. 1, mintey mouse system 100 in an “in use” condition 150 whereby user 140 may place a mintey mouse assembly 110 in a location where rodent deterrent is desired. Mintey mouse assembly 110 may comprise outer container 120. Outer container 120 may comprise inner volume 130, non-corrosive reservoir 220, and bottle 131. Non-corrosive reservoir 220 may comprise diffusing agent 213. Bottle 131 may comprise an essential oil liquid 200, which may discourage rodent occupation of area.

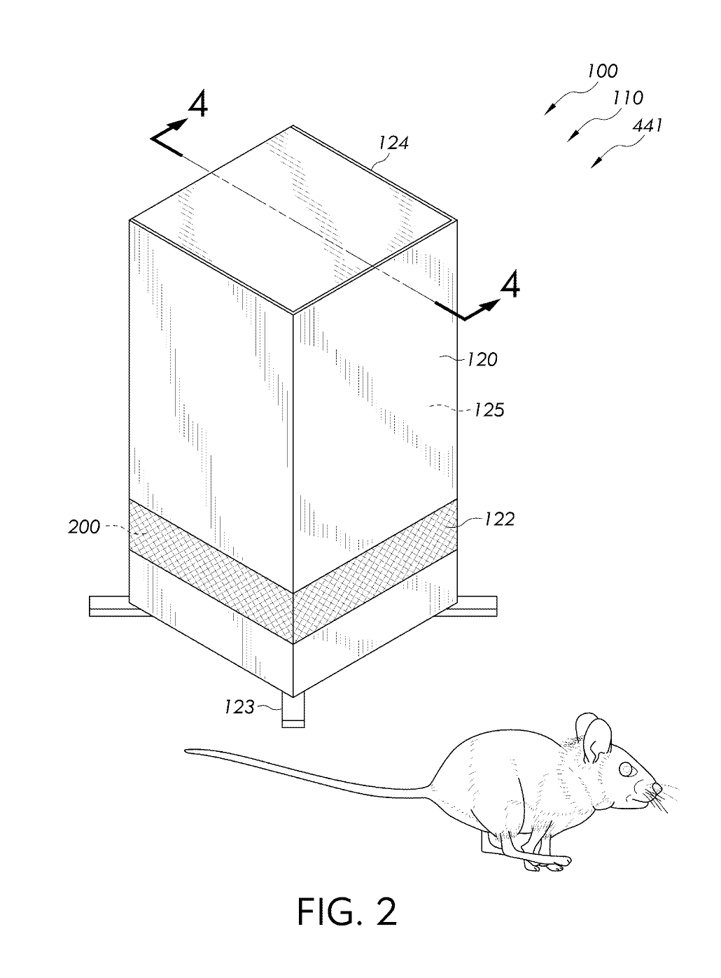

Referring now to FIG. 2, a perspective view of mintey mouse assembly 110 providing a deterrent. Mintey mouse assembly 110 may be structured and arranged in combination to provide a long-lasting rodent repellant for use. Mintey mouse assembly 110 may comprise outer container 120. Outer container 120 may comprise a cubic-shape 124, useful for placing outer container 120 in a corner of a room. Further, outer container 120 may comprise insular materials 125. Mintey mouse assembly 110 may be stabilized by anti-tipping feet. Airflow ventilation 122 may allow the essential oil liquid 200 vapors to diffuse into an ambient atmosphere.

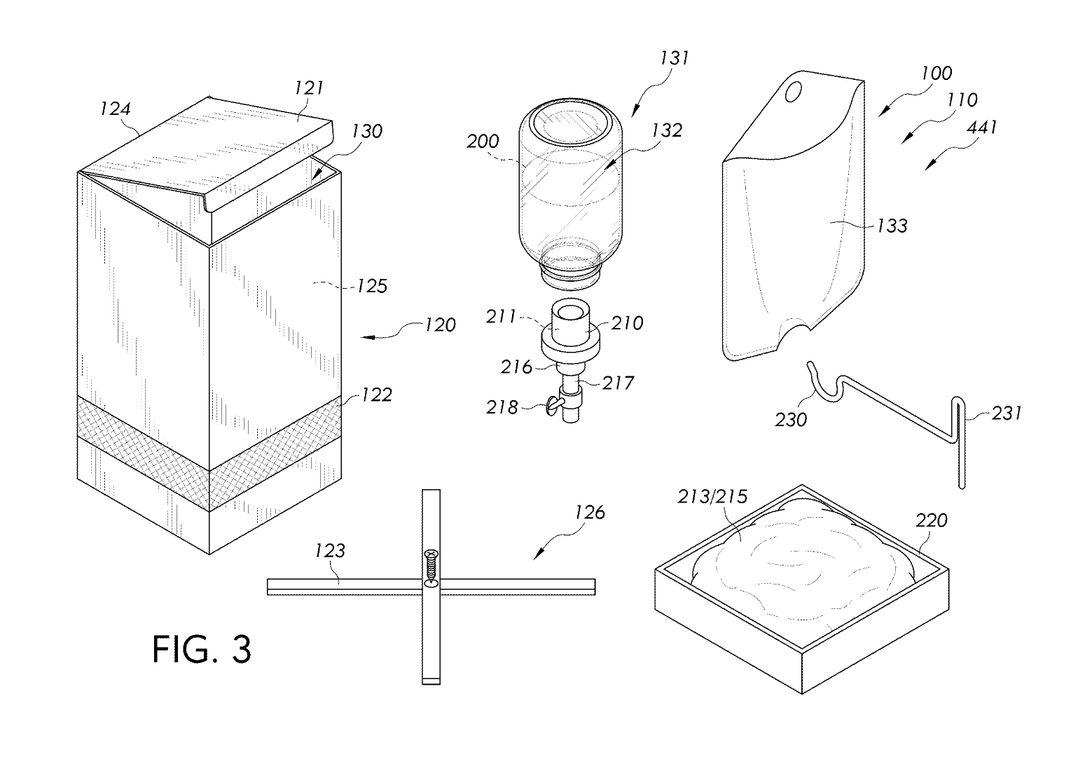

Referring now to FIG. 3, an exploded view of mintey mouse assembly 110, which may be structured and arranged to provide long-lasting rodent repellant. Mintey mouse assembly 110 may comprise outer container 120 and inner volume 130. The outer container 120 may comprise inner volume 130, non-corrosive reservoir 220, lid 121, airflow ventilation 122, and anti-tipping feet 123. The outer container 120 may comprise insular materials 125. The lid 121 may comprise an opening to access inner volume 130 for replacing and alternately removing bottle 131 for refilling with essential oil liquid 200, or alternately replacing bottle 131, non-corrosive rubber drip collar 211, non-corrosive nipple 216, and non-corrosive tube 217.

In continuing to refer to FIG. 3, inner volume may comprise hook 230, bottle-sack 133, bottle 131, and bottle receptacle 210. Bottle 131 may comprise essential oil liquid 200 suitable for dispersion. Bottle 131 may comprise a volume 132 structured and arranged for containing and controllably diffusing a quantity of essential oil liquid 200 that can last one year without requiring refill. Further, bottle receptacle 210 may comprise non-corrosive rubber drip collar 211, non-corrosive nipple 216, and non-corrosive tube 217. Non-corrosive tube 217 may comprise non-corrosive valve 218. Bottle-sack 133 is able to be removably-coupled with hook 230, useful for providing central suspension of bottle 131 in inner volume 130. Hook 230 may comprise attacher 231, useful for removably-coupling hook 230 to inner volume 130 of outer container 120.

In further referring to FIG. 3, anti-tipping feet 123 may comprise an x-shape 126, useful for providing stability for mintey mouse assembly 110. Non-corrosive reservoir 220 may comprise diffusing agent 213. Diffusing agent 213 may comprise cotton 215.

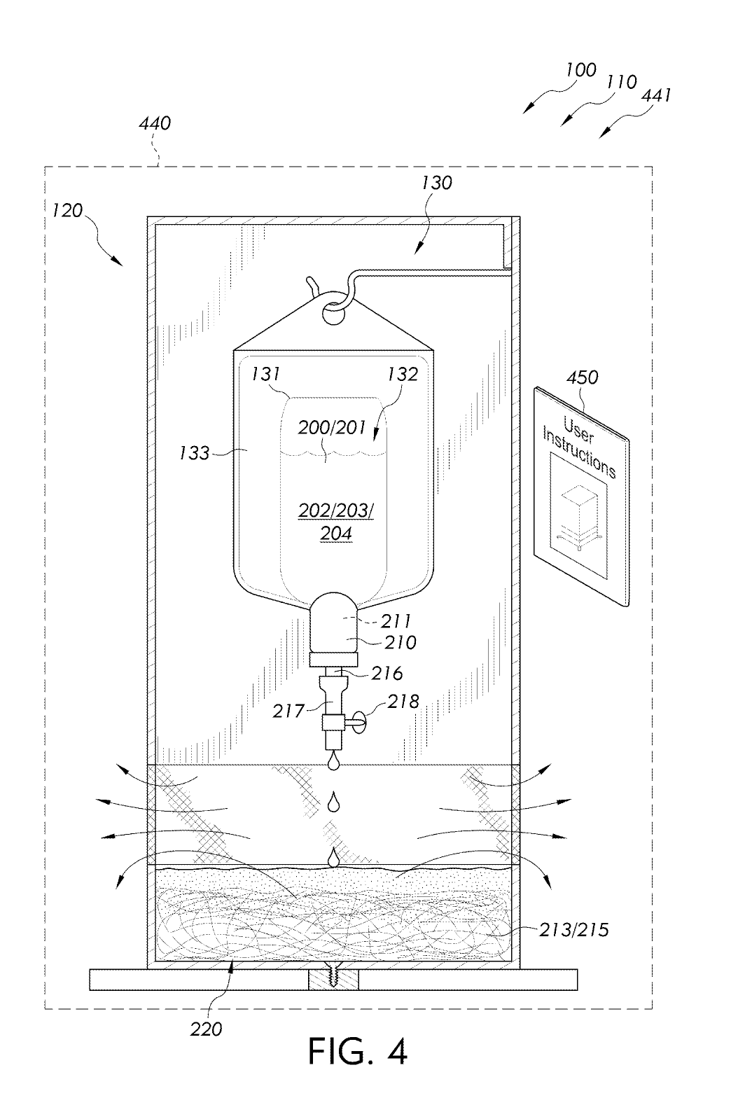

Referring now to FIG. 4, a cutaway view of a mintey mouse assembly 110. Mintey mouse assembly 110 may comprise outer container 120 and inner volume 130. Bottle 131 is removably-insertable to bottle-sack 133 useful for retaining bottle 131 in an opening-down position while removably-attached with bottle receptacle 210. The bottle receptacle 210 may comprise non-corrosive rubber drip collar 211, non-corrosive nipple 216, and non-corrosive tube 217 useful for allowing essential oil liquid vapors to diffuse into an ambient atmosphere. The non-corrosive valve 218 may comprise preset flow rates and an on/off condition, useful for controlling an amount of essential oil liquid 200 for diffusion.

In further referring to FIG. 4, essential oil liquid 200 may comprise non-poisonous agents 202, which are environmentally friendly. Essential oil liquid 200 may comprise peppermint oil 201, useful as a rodent deterrent. Further, essential oil liquid 200 may comprise anti-oxidation ingredients 203, useful for maintaining strength of peppermint oil 201, and essential oil liquid 200 may comprise non-toxic anti-freeze properties 204, useful for placing mintey mouse assembly 110 in cold locations.

Upon reading this specification, it should be appreciated that, under appropriate circumstances, considering such issues as user preferences, design preference, structural requirements, marketing preferences, cost, available materials, technological advances, etc., other mintey mouse system arrangements such as alternative shapes, alternative anti-tipping arrangements, alternative diffusing agents, alternative essential oil liquid combinations, essential oils that repel other undesirable pests such as insects, etc., may be sufficient.

Mintey mouse system 100 may be sold as kit 440 comprising the following parts: mintey mouse assembly; at least one mintey mouse assembly 110; at least one refill vial 441 of essential oil liquid 200 or alternately a replacement of the bottle 131, the non-corrosive rubber drip collar 211, the non-corrosive nipple 216, and the non-corrosive tube 217; and at least one set of user instructions 450. The kit has instructions such that functional relationships are detailed in relation to the structure of the invention (such that the invention can be used, maintained, or the like in a preferred manner). Mintey mouse system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different deterrent combinations, parts may be sold separately, etc., may be sufficient.

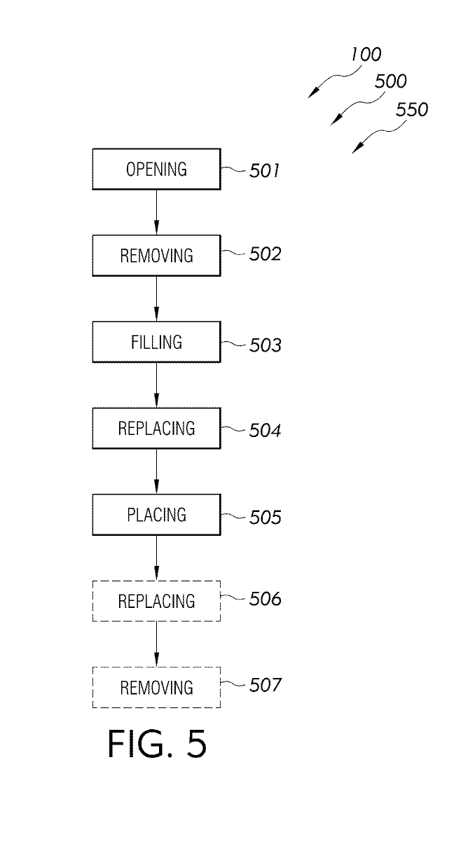

Referring now to FIG. 5 showing flowchart 550 illustrating method of use 500 for mintey mouse system 100 according to an embodiment of the present invention of FIGS. 1-4. As shown, method of use 500 may comprise the steps of: step one 501, opening lid 121 of outer container 120; step two 502, removing bottle 131; step three 503, filling bottle 131 with essential oil liquid 200; step four 504, replacing bottle 131 in outer container 120; step five 505, placing mintey mouse assembly 110 in desired location for rodent repelling; and step six 506, replacing the bottle 131, a non-corrosive rubber drip collar 211, the non-corrosive nipple 216, and the non-corrosive tube 217; and step seven 507, removing mintey mouse assembly 110 when use may no be longer desired.

It should be noted that steps 506 and 507 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A mintey mouse system comprising:
a mintey mouse assembly comprising;
an outer container comprising;
an inner volume comprising;
a hook;
a bottle-sack;
a bottle comprising;
an essential oil liquid;
a bottle receptacle comprising;
a non-corrosive rubber drip collar;
a non-corrosive nipple; and
a non-corrosive tube comprising;
a non-corrosive valve;
a non-corrosive reservoir comprising;
a diffusing agent;
a lid;
airflow ventilation; and
anti-tipping feet;
wherein said mintey mouse system comprises said mintey mouse assembly;
wherein said mintey mouse assembly comprises said outer container;
wherein said outer container comprises said inner volume, said non-corrosive reservoir, said lid, said airflow ventilation, and said anti-tipping feet;
wherein said inner volume comprises said hook, said bottle-sack, said bottle and said bottle receptacle;
wherein said bottle comprises said essential oil liquid suitable for dispersion;
wherein said bottle receptacle comprises said non-corrosive rubber drip collar, said non-corrosive nipple, and said non-corrosive tube;
wherein said non-corrosive tube comprises said non-corrosive valve;
wherein said non-corrosive reservoir comprises said diffusing agent; and
wherein said mintey mouse assembly is stabilized by said anti-tipping feet and is structured and arranged in combination to provide a long-lasting rodent repellant for use.

2. The mintey mouse system of claim 1 wherein said outer container comprises a cubic-shape, useful for placing said outer container in a corner of a room.

3. The mintey mouse system of claim 1 wherein said outer container comprises insular materials.

4. The mintey mouse system of claim 1 wherein said anti-tipping feet comprise an x-shape, useful for providing stability for said mintey mouse assembly.

5. The mintey mouse system of claim 1 wherein said hook comprises an attacher, useful for removably-coupling said hook to said inner volume of said outer container.

6. The mintey mouse system of claim 1 wherein said bottle-sack is able to be removably-coupled with said hook, useful for providing central suspension of said bottle in said inner volume.

7. The mintey mouse system of claim 1 wherein said bottle is removably-insertable to said bottle-sack useful for retaining said bottle in an opening-down position while removably-attached with said bottle receptacle.

8. The mintey mouse system of claim 1 wherein said bottle receptacle comprises said non-corrosive rubber drip collar, said non-corrosive nipple, and said non-corrosive tube useful for allowing said essential oil liquid vapors to diffuse into an ambient atmosphere.

9. The mintey mouse system of claim 1 wherein said non-corrosive valve comprises preset flow rates and an on/off condition, useful for controlling an amount of said essential oil liquid for diffusion.

10. The mintey mouse system of claim 1 wherein said diffusing agent comprises cotton.

11. The mintey mouse system of claim 1 wherein said essential oil liquid comprises non-poisonous agents, which are environmentally friendly.

12. The mintey mouse system of claim 1 wherein said essential oil liquid comprises peppermint oil, useful as a rodent deterrent.

13. The mintey mouse system of claim 12 wherein said essential oil liquid comprises anti-oxidation ingredients, useful for maintaining strength of said peppermint oil.

14. The mintey mouse system of claim 1 wherein said essential oil liquid comprises non-toxic anti-freeze properties, useful for placing said mintey mouse assembly in cold locations.

15. The mintey mouse system of claim 1 wherein said lid comprises an opening to access said inner volume for replacing and alternately removing said bottle for refilling with said essential oil liquid, or alternately replacing said bottle, said non-corrosive rubber drip collar, said non-corrosive nipple, and said non-corrosive tube.

16. The mintey mouse system of claim 1 wherein said bottle comprises a volume structured and arranged for containing and controllably diffusing a quantity of said essential oil liquid that can last one year without requiring refill.

17. A mintey mouse system comprising:
a mintey mouse assembly comprising;
an outer container comprising;
an inner volume comprising;
a hook;
a bottle-sack;
a bottle comprising;
an essential oil liquid;
a bottle receptacle comprising;
a non-corrosive rubber drip collar;
a non-corrosive nipple; and
a non-corrosive tube comprising;
a non-corrosive valve;
a secondary non-corrosive reservoir comprising;
a diffusing agent;
a lid;
airflow ventilation; and
anti-tipping feet;
wherein said mintey mouse system comprises said mintey mouse assembly;
wherein said mintey mouse assembly comprises said outer container;
wherein said outer container comprises said inner volume, said non-corrosive reservoir, said lid, said airflow ventilation, and said anti-tipping feet;
wherein said inner volume comprises said hook, said bottle-sack, said bottle and said bottle receptacle;
wherein said bottle receptacle comprises said non-corrosive rubber drip collar, said non-corrosive nipple, and said non-corrosive tube;
wherein said non-corrosive tube comprises said non-corrosive valve;
wherein said non-corrosive reservoir comprises said diffusing agent;
wherein said bottle comprises said essential oil liquid suitable for dispersion therefrom;
wherein said outer container comprises a cubic-shape, useful for placing said outer container in a corner of a room;
wherein said outer container comprises insular materials;
wherein said anti-tipping feet comprise an x-shape, useful for providing stability for said mintey mouse assembly;
wherein said hook comprises an attacher, useful for removably-coupling said hook to said inner volume of said outer container;
wherein said bottle-sack is able to be removably-coupled with said hook, useful for providing central suspension of said bottle in said inner volume;
wherein said bottle is removably-insertable to said bottle-sack useful for retaining said bottle in an opening-down position while removably-attached with said bottle receptacle;
wherein said bottle receptacle comprises said non-corrosive rubber drip collar, said non-corrosive nipple, and said non-corrosive tube useful for allowing said essential oil liquid vapors to diffuse into an ambient atmosphere;
wherein said non-corrosive valve comprises preset flow rates and an on/off condition, useful for controlling an amount of said essential oil liquid for diffusion;
wherein said diffusing agent comprises cotton;
wherein said essential oil liquid comprises non-poisonous agents, which are environmentally friendly;
wherein said essential oil liquid comprises peppermint oil, useful as a rodent deterrent;
wherein said essential oil liquid comprises anti-oxidation ingredients, useful for maintaining strength of said peppermint oil;
wherein said essential oil liquid comprises non-toxic anti-freeze properties, useful for placing said mintey mouse assembly in cold locations;
wherein said lid comprises an opening to access said inner volume for replacing and alternately removing said bottle for refilling with said essential oil liquid, or alternately replacing said bottle, said non-corrosive rubber drip collar, said non-corrosive nipple, and said non-corrosive tube; and
wherein said bottle comprises a volume structured and arranged for containing and controllably diffusing a quantity of said essential oil liquid that can last one year without requiring refill.

18. The mintey mouse system of claim 17 further comprising a kit including:
said mintey mouse assembly;
a refill vial of said essential oil liquid, or alternately a replacement of said bottle, said non-corrosive rubber drip collar, said non-corrosive nipple, and said non-corrosive tube; and
a set of user instructions;

19. A method of using a mintey mouse system comprising the steps of:
opening a lid of an outer container;
removing a bottle;
filling said bottle with essential oil liquid;
replacing said bottle in said outer container; and
placing a mintey mouse assembly in a desired location for rodent repelling.

20. The method of claim 19 further comprising the steps of: replacing said bottle, a non-corrosive rubber drip collar, a non-corrosive nipple, and a non-corrosive tube; and removing said mintey mouse assembly when use is no longer desired.
